(19) United States
(12) Patent Application Publication
(10) Pub. No.: US 2025/0199328 A1
(43) Pub. Date: Jun. 19, 2025

(54) CAMERA MODULE

(71) Applicant: SAMSUNG ELECTRO-MECHANICS CO., LTD., Suwon-si (KR)

(72) Inventors: Bo Sung SEO, Suwon-si (KR); Young Hwan KWON, Suwon-si (KR)

(73) Assignee: SAMSUNG ELECTRO-MECHANICS CO., LTD., Suwon-si (KR)

(21) Appl. No.: 18/958,118

(22) Filed: Nov. 25, 2024

(30) Foreign Application Priority Data
Dec. 19, 2023 (KR) 10-2023-0186321

(51) Int. Cl. G02B 27/64; G03B 5/00; G03B 30/00

(52) U.S. Cl. CPC G02B 27/646; G03B 5/00; G03B 30/00; G03B 2205/0023; G03B 2205/0069

(57) ABSTRACT

A camera module is provided. The camera module includes a housing, a rotation holder supported by the housing, and configured to rotate together with a reflective member, and a first plurality of ball members disposed between the housing and the rotation holder. The housing and the rotation holder respectively have guide grooves that accommodate a first set of ball members of the first plurality of ball members. A first set of guide grooves, among the guide grooves, include a plurality of partition walls that protrude toward an internal space of the guide grooves in which the first set of ball members of the first plurality of ball members are accommodated and disposed to be spaced apart from each other in a direction of extension of the guide groove.

### CROSS-REFERENCE TO RELATED APPLICATIONS

This application claims the benefit under 35 USC § 119 (a) of Korean Patent Application No. 10-2023-0186321 filed on Dec. 19, 2023, in the Korean Intellectual Property Office, the entire disclosure of which is incorporated herein by reference for all purposes.

### BACKGROUND

### 1. Field

The following description relates to a camera module.

### 2. Description of Related Art

Camera modules are implemented in mobile communication terminals such as, but not limited to, smartphones, tablet personal computers (PCs), and laptop computers. An autofocus (AF) operation and an optical image stabilization (OIS) operation have been implemented in camera modules provided in mobile communication terminals.

In camera modules including a reflective member, an OIS operation may be implemented by rotating the reflective member (or a structure including the reflective member) about two axes, perpendicular to an optical axis, with respect to a housing.

For example, a ball member may be disposed between a carrier on which the reflective member is mounted and the housing. The ball member may be disposed in an accommodation groove provided in the carrier and the housing, and may assist the carrier in moving with respect to the housing while moving in a rolling motion in the accommodation groove, when the carrier moves with respect to the housing. Additionally, the accommodation groove may be formed to have a width which does not limit a direction of movement of the ball member, such that the ball member moves in a smooth rolling motion.

However, in a structure of the accommodation groove described above, when the ball member is at a specific position in the accommodation groove, the ball member may no longer move in a rolling motion in the direction of movement and slide, which may hinder movement of the carrier.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a housing; a rotation holder, supported by the housing, and configured to rotate together with a reflective member; and a first plurality of ball members disposed between the housing and the rotation holder, wherein the housing and the rotation holder respectively have guide grooves that accommodate a first set of ball members of the first plurality of ball members, and a first set of guide grooves, among the guide grooves, comprise a plurality of partition walls that protrude toward an internal space of the guide grooves in which the first set of ball members of the first plurality of ball members are accommodated, and are disposed to be spaced apart from each other in a direction of extension of the guide groove.

The guide grooves may include a first guide groove provided on the rotation holder, the first guide groove extending approximately in a direction of rotation of the rotation holder; and a second guide groove provided on the housing to correspond to the first guide groove, wherein the first guide groove may include the plurality of partition walls.

The plurality of partition walls may include a first partition wall and a second partition wall disposed to be spaced apart from each other in a direction of extension of the first guide groove, and a first distance between a first point of the first partition wall in contact with a ball member accommodated in the first guide groove and a second point of the second partition wall in contact with the ball member accommodated in the first guide groove may be less than a diameter of the ball member accommodated in the first guide groove.

The plurality of partition walls may further include a third partition wall disposed to oppose a separation space formed between the first partition wall and the second partition wall.

A second distance between the first point of the first partition wall and the second point of the second partition wall in contact with the ball member accommodated in the first guide groove and a third point of the third partition wall in contact with the ball member accommodated in the first guide groove may be less than the diameter of the ball member accommodated in the first guide groove.

The third point may be disposed at approximately a central portion of the third partition wall.

A third distance between the first point of the first partition wall and the second point of the second partition wall in contact with the ball member accommodated in the first guide groove and a fourth point of one side surface of the first guide groove, opposing the first partition wall and the second partition wall, in contact with the ball member accommodated in the first guide groove may be less than the diameter of the ball member accommodated in the first guide groove.

The first plurality of ball members may include a rotation axis ball that forms a rotation axis of the rotation holder; and a plurality of guide balls that are disposed spaced apart from the rotation axis ball and are accommodated in the guide groove.

The camera module may include a reflective holder supported by the rotation holder, and configured to rotate together with the reflective member; and a second plurality of ball members disposed between the rotation holder and the reflective holder, wherein the rotation holder and the reflective holder may each be configured to rotate about axes, perpendicular to each other.

The first set of ball members of the first plurality of ball members may be disposed between the first guide groove and the second guide groove, and a number of contact points between the first set of ball members of the first plurality of ball members and the first guide groove may be greater than a number of contact points between the first set of ball members of the first plurality of ball members and the second guide groove.

In a general aspect, a camera module includes a rotation holder accommodated in a housing and configured to rotate about a first axis; a plurality of ball members disposed between the housing and the rotation holder; and a first guide groove that accommodates a first set of ball members, among the plurality of ball members, and extending approximately in a direction of rotation of the rotation holder, wherein the first guide groove has a first side surface and a second side surface opposing each other and extending in a direction of rotation of the rotation holder, and a third side surface and a fourth side surface positioned on the direction of rotation of the rotation holder and connecting the first side surface and the second side surface to each other, and the first set of ball members are accommodated in the first guide groove, and are in contact with at least one side surface, among the first side surface and the second side surface, and are disposed apart from the third side surface and the fourth side surface during the rotation of the rotation holder.

At least one of the first side surface and the second side surface may include a partition wall that protrudes toward an internal space of the first guide groove, and the first set of ball members may be in contact with the partition wall.

One of the first side surface and the second side surface may include a first partition wall and a second partition wall disposed to be spaced apart from each other in a direction of extension of the first guide groove.

The one of the first side surface and the second side surface may further include a third partition wall disposed to oppose a separation space formed between the first partition wall and the second partition wall.

A distance between a first point of the first partition wall in contact with the first set of ball members and a second point of the second partition wall in contact with the first set of ball members, and a distance between the first point of the first partition wall and the second point of the second partition wall and a third point of the third partition wall in contact with the first set of ball members may respectively be less than a diameter of the first set of ball members.

A distance between a first point of the first partition, in contact with the first set of ball members, and a second point of the second partition, in contact with the first set of ball members, and a distance between the first point of the first partition and the second point of the second partition and a fourth point of one side surface of the first guide groove opposing the first partition wall and the second partition wall, in contact with the first set of ball members, is respectively less than a diameter of the first set of ball members.

The housing may have a second guide groove that opposes the first guide groove, and accommodates a second set of ball members of the plurality of ball members accommodated in the first guide groove, and the second guide groove may have a cross-sectional shape in at least one direction, different from a cross-sectional shape of the first guide groove.

A number of contact points between the first set of ball members and the first guide groove may be greater than a number of contact points between the first set of ball members and the second guide groove.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates an exploded perspective view of an example camera module, in accordance with one or more embodiments.

FIG. 3 illustrates a perspective view of the example camera module in FIG. 1 with a case removed.

FIG. 4 illustrates a perspective view of a first lens module and a reflective module coupled to a housing, in accordance with one or more embodiments.

FIG. 5 illustrates a perspective view of a first lens module and a reflective module, coupled to each other, in accordance with one or more embodiments.

FIG. 6 illustrates an exploded perspective view of a first lens module and a reflective module, in accordance with one or more embodiments.

FIG. 7 illustrates a bottom exploded perspective view of a first lens module and a reflective module, in accordance with one or more embodiments.

FIG. 8 illustrates a cross-sectional view taken along line I-I′ of FIG. 4.

FIG. 9 illustrates a cross-sectional view taken along line II-II′ of FIG. 4.

FIG. 10 illustrates a bottom view of a rotation holder, in accordance with one or more embodiments.

FIG. 11 illustrates an enlarged view of a first guide groove provided in a rotation holder, in accordance with one or more embodiments.

FIG. 12 illustrates a diagram of a guide groove provided in another rotation holder, in accordance with one or more embodiments.

FIGS. 13A and 13B are diagrams of a position of a guide ball when a rotation holder rotates, in accordance with one or more embodiments.

FIG. 14 illustrates an exploded perspective view of a second lens module, in accordance with one or more embodiments.

FIG. 15 illustrates a bottom exploded perspective view of a second lens module, in accordance with one or more embodiments.

FIG. 16 is a diagram of a board separated from a housing, in accordance with one or more embodiments.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

In addition, the terms “upper side,” “upper portion,” lower side,” “lower portion,” “side surface,” “front surface,” “rear surface” and the like are described based on a direction illustrated the drawings, and may be described differently when a direction of a corresponding object is changed.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide a camera module having an improved optical image stabilization operation, more specifically, to a camera module having improved driving stability when a yaw axis of a reflective member rotates.

In accordance with one or more examples, a rolling motion of a ball member may not be hindered, thereby improving optical image stabilization performance of a camera module.

As used herein, a first axis or a first axis direction may refer to an X-axis or an X-axis direction of the drawings, a second axis or a second axis direction may refer to a Y-axis or a Y-axis direction of the drawings, and an optical axis (third axis) or an optical axis direction (third axis direction) may refer to a Z-axis or a Z-axis direction of the drawings. Additionally, the first axis may be a direction, perpendicular to the optical axis, and the second axis may be a direction, perpendicular to both the optical axis and the first axis.

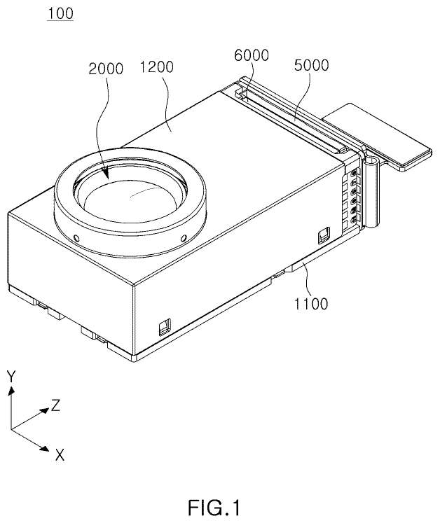

FIG. 1 is a perspective view of an example camera module, in accordance with one or more embodiments.

A camera module 100, illustrated in FIG. 1, may be implemented in portable electronic devices such as, but not limited to, mobile communication terminals, smartphones, tablet PCs, and the like. Several types of camera modules may be implemented in portable electronic devices, and the camera module 100 illustrated in FIG. 1 may be one of the several types of camera modules.

The camera module 100, illustrated in FIG. 1, may be provided in a portable electronic device such that a height direction (Y-axis direction) of the camera module 100 is parallel to a thickness direction of the portable electronic device. Accordingly, light, reflected from an external subject, may be incident on the camera module 100 in a direction, parallel to the height direction (Y-axis direction) of the camera module 100.

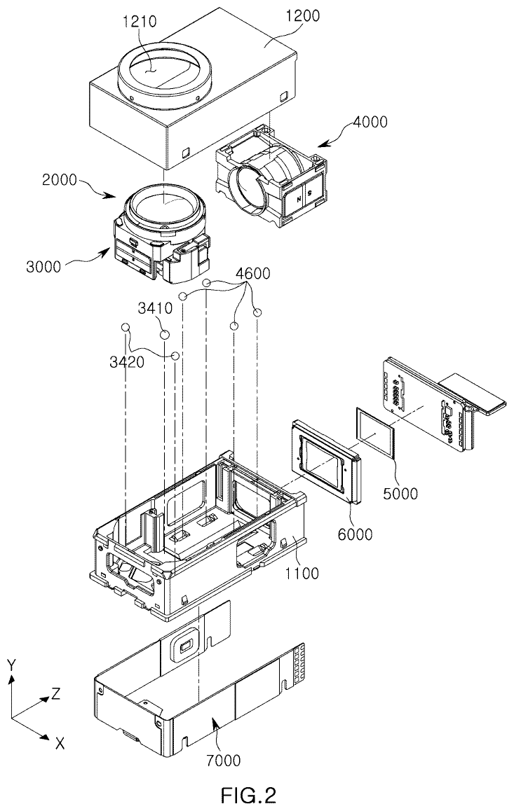

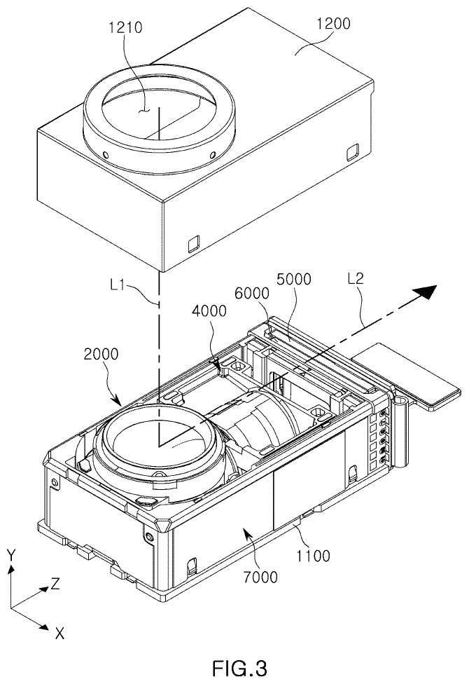

FIG. 2 is an exploded perspective view of an example camera module, in accordance with one or more embodiments. FIG. 3 is a perspective view of the example camera module in FIG. 1 with a case separated.

Referring to FIGS. 2 and 3, the camera module 100, in accordance with one or more embodiments, may include a housing 1100, a case 1200, a plurality of lens modules 2000 and 4000, a reflective module 3000, and an image sensor 5000.

The housing 1100 and the case 1200 may form the exterior of the camera module 100. In an example embodiment, the housing 1100 may have a rectangular box shape having an internal space, and the case 1200 may be coupled to the housing 1100 to cover the internal space.

The case 1200 may protect components disposed in the housing 1100. Additionally, the case 1200 may shield electromagnetic waves. Accordingly, in an example, the case 1200 may be formed of a metal material.

The plurality of lens modules 2000 and 4000, the reflective module 3000, and the image sensor 5000 may all be disposed in the housing 1100. In an example embodiment, the plurality of lens modules 2000 and 4000 and the reflective module 3000 may be accommodated in the internal space of the housing 1100, and the image sensor 5000 may be coupled to the outside (external surface) of the housing 1100 through a filter unit 6000. In another example embodiment, the image sensor 5000 may be accommodated in the internal space of the housing 1100.

The plurality of lens modules 2000 and 4000 may include a first lens module 2000 and a second lens module 4000, having different optical axes. The reflective module 3000, which changes a path of incident light, may be disposed between the first lens module 2000 and the second lens module 4000.

The reflective module 3000 may change the path of incident light from a direction (L1 direction) of an optical axis (hereinafter referred to as a first optical axis) of the first lens module 2000 to a direction (L2 direction) of an optical axis (hereinafter referred to as a second optical axis) of the second lens module 4000. The first optical axis direction (L1 direction) and the second optical axis direction (L2) may be substantially perpendicular to each other.

Referring to FIG. 3, light, reflected from an external subject (hereinafter referred to as incident light), may be incident on the first lens module 2000 through an opening 1210 of the case 1200. Incident light may pass through the first lens module 2000, and may sequentially pass through the reflective module 3000, disposed below the first lens module 2000, and the second lens module 4000, positioned on the changed path, to be incident on the image sensor 5000.

The image sensor 5000 may convert incident light into an electrical signal. The electrical signal, converted by the image sensor 5000, may be output as an image through a display device of a portable electronic device.

The image sensor 5000 may be mounted on a printed circuit board, and may be electrically connected to the printed circuit board.

A filter unit 6000 may be disposed in front of the image sensor 5000 to filter light, having a specific wavelength, of light passing through the second lens module 4000. In a non-limited example embodiment, the filter unit 6000 may be an infrared blocking filter, that blocks light having an infrared wavelength.

The camera module 100, in accordance with one or more embodiments, may have an optical image stabilization (OIS) operation and an autofocus (AF) operation.

In an example embodiment, the OIS operation of the camera module 100 may be implemented by rotating the first lens module 2000 and the reflective module 3000 about two rotation axes (hereinafter referred to as a first axis (X-axis) and a second axis (Y-axis)), perpendicular to a second optical axis L2 (hereinafter referred to as an optical axis (Z-axis)). The first axis (X-axis) and the second axis (Y-axis) may be perpendicular to each other. Additionally, the AF operation of the camera module 100 may be implemented by moving the second lens module 4000 in an optical axis direction (Z-axis direction).

Additionally, in another example embodiment, the camera module 100 may further have a zoom operation. For example, to implement the zoom operation, the second lens module 4000 may include a plurality of lens barrels or lens holders, and the zoom operation may be implemented by moving at least some barrels or lens holders, among the plurality of lens barrels or lens holders, in the optical axis direction (Z-axis direction).

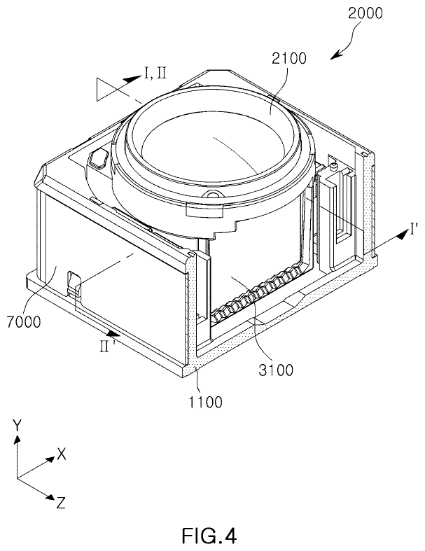

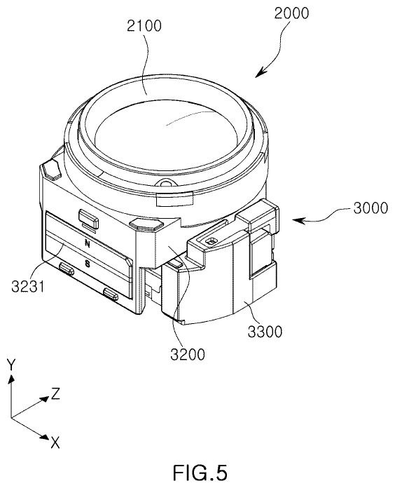

FIG. 4 is a perspective view of a first lens module and a reflective module coupled to a housing, in accordance with one or more embodiments. FIG. 5 is a perspective view of a first lens module and a reflective module, coupled to each other, in accordance with one or more embodiments.

The first lens module 2000 and the reflective module 3000 may respectively include an optical element. In an example embodiment, the first lens module 2000 may include at least one lens, and the reflective module 3000 may include a reflective member 3100.

Referring to FIGS. 4 and 5, the first lens module 2000 and the reflective module 3000 may be accommodated in an internal space of the housing 1100 in a state in which the first lens module 2000 and the reflective module 3000 are coupled to each other. Accordingly, when OIS of the camera module 100 is performed, the first lens module 2000 and the reflective module 3000 may rotate together about a first axis (X-axis) and a second axis (Y-axis).

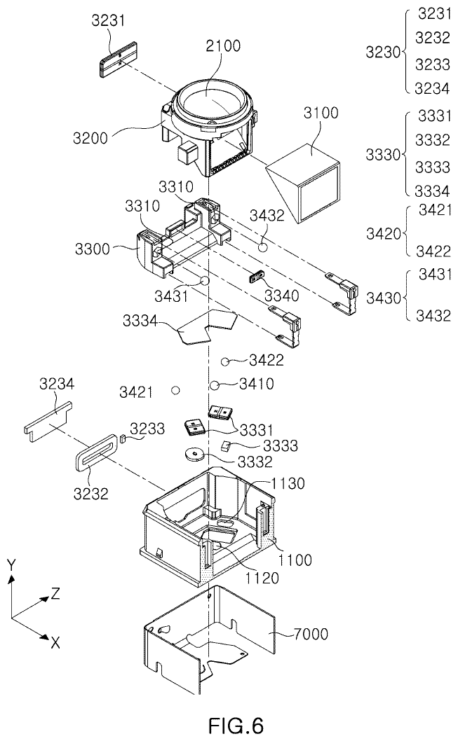

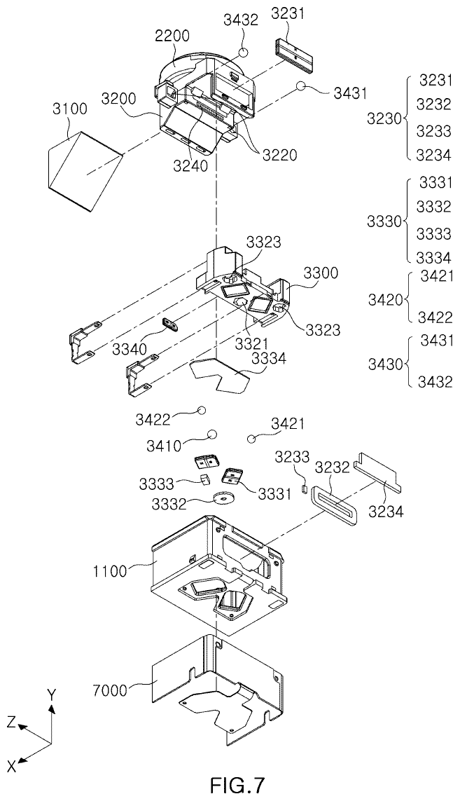

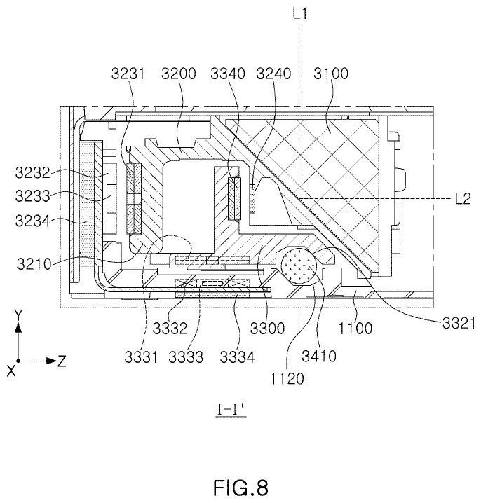

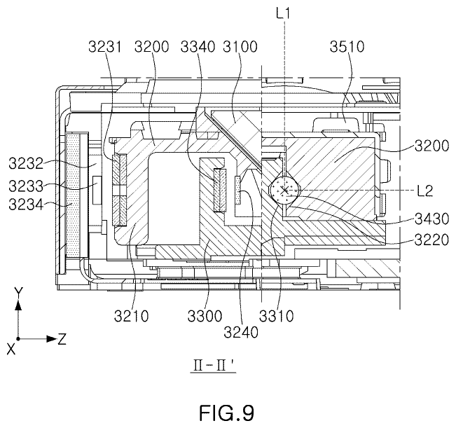

FIG. 6 is an exploded perspective view of a first lens module and a reflective module, in accordance with one or more embodiments. FIG. 7 is a bottom exploded perspective view of a first lens module and a reflective module, in accordance with one or more embodiments. FIG. 8 is a cross-sectional view taken along line I-I′ of FIG. 4. FIG. 9 is a cross-sectional view taken along line II-II′ of FIG. 4.

The first lens module 2000 may include a first lens barrel 2100 on which at least one lens is mounted.

The reflective module 3000 may include a reflective holder 3200, on which the reflective member 3100 is mounted, and a rotation holder 3300 by which the reflective holder 3200 is supported.

The first lens barrel 2100 may be coupled to an upper side of the reflective holder 3200.

The reflective member 3100 may be mounted in the reflective holder 3200. The reflective member 3100 may change a path of incident light. In an example embodiment, the reflective member 3100 may be a mirror or prism, as examples. The reflective member 3100 may have a reflective surface, that reflects incident light to change the path of incident light. The center of the reflective surface may approximately correspond to a first optical axis (L1) of the first lens module 2000.

The reflective holder 3200 may rotate using a first axis (X-axis) as a rotation axis. The reflective member 3100 and the first lens module 2000 may rotate together with the reflective holder 3200.

The reflective holder 3200 may rotate when supported by the rotation holder 3300. A first ball group 3430 that forms a rotation axis of the reflective holder 3200, that is, the first axis (X-axis), may be disposed between the reflective holder 3200 and the rotation holder 3300.

In an example embodiment, the first ball group 3430 may include at least two ball members disposed to be spaced apart from each other in a first axis direction (X-axis direction). The first axis (X-axis) may pass through approximately the center of the reflective surface.

The rotation holder 3300 may rotate using a second axis (Y-axis) as a rotation axis. The reflective holder 3200 may rotate together with the rotation holder 3300, and accordingly components rotating together with the reflective holder 3200, that is, the reflective member 3100 and the first lens module 2000, may also rotate together with the rotation holder 3300.

The rotation holder 3300 may rotate when supported by the housing 1100. Second ball groups 3410 and 3420 may be disposed between the rotation holder 3300 and the housing 1100.

In an example embodiment, the second ball groups 3410 and 3420 may include one rotation axis ball 3410 that forms the second axis (Y-axis), a rotation axis of the rotation holder 3300, and a plurality of guide balls 3420 (3421 and 3422) stably supporting rotation of the rotation holder 3300.

The second axis (Y-axis) may pass through the rotation axis ball 3410. The second axis (Y-axis) may be approximately parallel to the first optical axis (L1), such that at least one lens and the center of the reflective surface may be disposed on the second axis (Y-axis). One or more guide balls 3420 may be provided, and may be disposed to be spaced apart from the rotation axis ball 3410.

In an example embodiment, the first axis (X-axis), the rotation axis of the reflective holder 3200, and the second axis (Y-axis), the rotation axis of the rotation holder 3300, may intersect each other, and an intersection point thereof may be positioned on the reflective surface (approximately the center of the reflective surface) of the reflective member 3100.

The reflective module 3000 may include a first driving unit 3230 that generates a driving force to rotate the reflective holder 3200 about the first axis (X-axis), and a second driving unit 3330 that generates a driving force to rotate the rotation holder 3300 about the second axis (Y-axis).

The first driving unit 3230 may include a first driving magnet 3231 and a first driving coil 3232.

The first driving magnet 3231 may be disposed in the reflective holder 3200. In an example embodiment, the reflective holder 3200 may include an extension portion 3210 extending to a space between the rotation holder 3300 and the housing 1100. The extension portion 3210 may be a portion of the reflective holder 3200, opposing one side surface of the housing 1100. The first driving magnet 3231 may be disposed in the extension portion 3210 of the reflective holder 3200.

The first driving coil 3232 may be disposed in the housing 1100. Specifically, as a board 7000 on which the first driving coil 3232 is mounted is coupled to the housing 1100, the first driving coil 3232 may be disposed in the housing 1100.

The first driving magnet 3231 and the first driving coil 3232 may oppose each other when disposed in the reflective holder 3200 and the housing 1100, respectively.

The first driving magnet 3231 may be a moving member disposed in the reflective holder 3200, the moving member rotating together with the reflective holder 3200, and the first driving coil 3232 may be a fixed member fixedly disposed in the housing 1100, but the one or more examples are not limited thereto, and positions thereof may be interchanged.

When power is applied to the first driving coil 3232, the reflective holder 3200 may rotate about the first axis (X-axis) due to a driving force generated by electromagnetic interaction between the first driving coil 3232 and the first driving magnet 3231.

The first ball group 3430, supporting rotation of the reflective holder 3200 while forming a rotation axis, may be disposed between the reflective holder 3200 and the rotation holder 3300.

In an example embodiment, the first ball group 3430 may include two ball members 3431 and 3432 disposed to be spaced apart from each other in the first axis direction (X-axis direction). The reflective member 3100 may be disposed between the two ball members 3431 and 3432.

The reflective holder 3200 and the rotation holder 3300 may respectively have accommodation grooves 3220 and 3310 that accommodate a portion of the two ball members 3431 and 3432.

In an example embodiment, the reflective holder 3200 may have two first accommodation grooves 3220 disposed to be spaced apart from each other in the first axis direction (X-axis direction), and the rotation holder 3300 may have two second accommodation grooves 3310 disposed to be spaced apart from each other in the first axis direction (X-axis direction).

The two ball members 3431 and 3432 may form the first axis (X-axis) while rotating in place when accommodated in the first and second accommodation grooves 3220 and 3310.

At least one of the first accommodation groove 3220 and the second accommodation groove 3310 may support a ball member at at least three points. In an example embodiment, at least one of the two first accommodation grooves 3220 and the two second accommodation grooves 3310 may have three inclined surfaces, and the other grooves may have at least two inclined surfaces. In other words, at least one of the two ball members 3431 and 3432 may be supported at three points by at least one of the first accommodation groove 3220 and the second accommodation groove 3310.

The first accommodation groove 3220 and the second accommodation groove 3310 may oppose each other in an optical axis direction (Z-axis direction). In order to prevent the two ball members 3431 and 3432 disposed between the first accommodation groove 3220 and the second accommodation groove 3310 from departing, the reflective holder 3200 may be supported by the rotation holder 3300 in the optical axis direction (Z-axis direction).

Referring to FIGS. 8 and 9, the reflective holder 3200 may be supported by the rotation holder 3300 based on a magnetic force that is generated between a pair of magnetic bodies 3240 and 3340.

The pair of magnetic bodies 3240 and 3340 may include a first magnetic body 3240 disposed in the reflective holder 3200, and a second magnetic body 3340 disposed in the rotation holder 3300. The first magnetic body 3240 and the second magnetic body 3340 may be disposed to oppose each other in the optical axis direction (Z-axis direction).

In an example embodiment, the first magnetic body 3240 may be a pulling yoke, and the second magnetic body 3340 may be a pulling magnet. A magnetic attraction force may be formed between the first magnetic body 3240 and the second magnetic body 3340 in opposing directions. Accordingly, the reflective holder 3200 may be supported by the rotation holder 3300 to be in close contact with the rotation holder 3300 in the optical axis direction (Z-axis direction), with the two ball members 3431 and 3432 interposed therebetween.

A first yoke 3234 may be disposed on a rear surface of the board 7000 on which the first driving coil 3232 is mounted. The first yoke 3234 may be disposed to oppose the first driving magnet 3231 with the first driving coil 3232 interposed therebetween.

The first yoke 3234 may have an operation of focusing a magnetic force of the first driving magnet 3231.

Additionally, a first position sensor 3233, that senses a position of the first driving magnet 3231, may be mounted on the board 7000. The first position sensor 3233 may be disposed on the inside or the outside of the first driving coil 3232, and one or more first position sensors 3233 may be provided.

The first position sensor 3233 may be a magnetic sensor, for example, a Hall sensor. The first position sensor 3233 may be disposed to oppose the first driving magnet 3231, and may sense a change in magnetic flux, thereby sensing an amount of movement of the first driving magnet 3231.

The second driving unit 3330 may include a second driving magnet 3331 and a second driving coil 3332.

The second driving magnet 3331 may be disposed in the rotation holder 3300. In an example embodiment, the second driving magnet 3331 may be disposed on a bottom surface of the rotation holder 3300.

The second driving coil 3332 may be disposed in the housing 1100. Specifically, as the board 7000 on which the second driving coil 3332 is mounted is coupled to the housing 1100, the second driving coil 3332 may be disposed in the housing 1100.

The second driving magnet 3331 and the second driving coil 3332 may oppose each other in a state of being disposed in the rotation holder 3300 and the housing 1100, respectively.

The second driving magnet 3331 may be a moving member disposed in the rotation holder 3300, the moving member may rotate together with the rotation holder 3300, and the second driving coil 3332 may be a fixed member fixedly disposed in the housing 1100, but the one or more examples are not limited thereto, and positions thereof may be interchanged.

When power is applied to the second driving coil 3332, the rotation holder 3300 may rotate about the second axis (Y-axis) due to a driving force generated by electromagnetic interaction between the second driving coil 3332 and the second driving magnet 3331.

The second ball groups 3410 and 3420, that support a rotation of the rotation holder 3300 while forming a rotation axis, may be disposed between the rotation holder 3300 and the housing 1100.

In an example embodiment, the second ball groups 3410 and 3420 may include one rotation axis ball 3410 through which the second axis (Y-axis) passes, and two guide balls 3420 (3421 and 3422) disposed to be spaced apart from the one rotation axis ball 3410.

The rotation holder 3300 and the housing 1100 may respectively have accommodation grooves 3321 and 1120 accommodating a portion of the one rotation axis ball 3410.

In an example embodiment, the rotation holder 3300 may have a third accommodation groove 3321 at a position through which the second axis (Y-axis) passes, and the housing 1100 may have a fourth accommodation groove 1120 at a position through which the second axis (Y-axis) passes.

The one rotation axis ball 3410 may form a second axis (Y-axis) while rotating in place in a state of being accommodated in the third and fourth accommodation grooves 3321 and 1120.

At least one of the third accommodation groove 3321 and the fourth accommodation groove 1120 may support the rotation axis ball 3410 at at least three points, such that a position of the rotation axis ball 3410 may be fixed. In an example embodiment, at least one of the third accommodation groove 3321 and the fourth accommodation groove 1120 may have three inclined surfaces, and the rotation axis ball 3410 may be supported by point contact with each inclined surface.

Additionally, the rotation holder 3300 and the housing 1100 may respectively have guide grooves 3323 and 1130 that accommodate a portion of the two guide balls 3421 and 3422.

In an example embodiment, the rotation holder 3300 may have two first guide grooves 3323 disposed to be spaced apart from the third accommodation groove 3321, and the housing 1100 may have two second guide grooves 1130 disposed to be spaced apart from the fourth accommodation groove 1120.

The two guide balls 3421 and 3422 may guide a rotation of the rotation holder 3300 while moving in a rolling motion in a direction of rotation of the rotation holder 3300 in a state of being accommodated in the first guide groove 3323 and the second guide groove 1130.

The first guide groove 3323 and the second guide groove 1130 may be in the form of extending in a direction of movement of the two guide balls 3421 and 3422. In an example embodiment, the first guide groove 3323 and the second guide groove 1130 may be in the form of a curved or straight line extending approximately in a circumferential direction of a circle centered about the second axis (Y-axis) (or the rotation axis ball 3410), that is, in a direction of rotation of the rotation holder 3300.

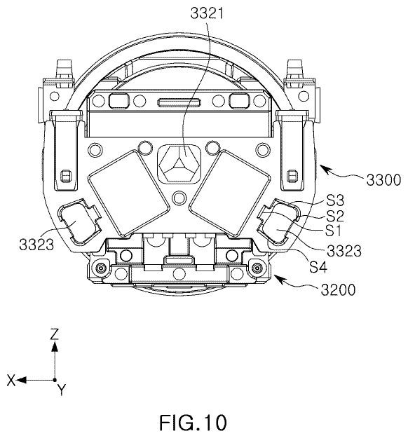

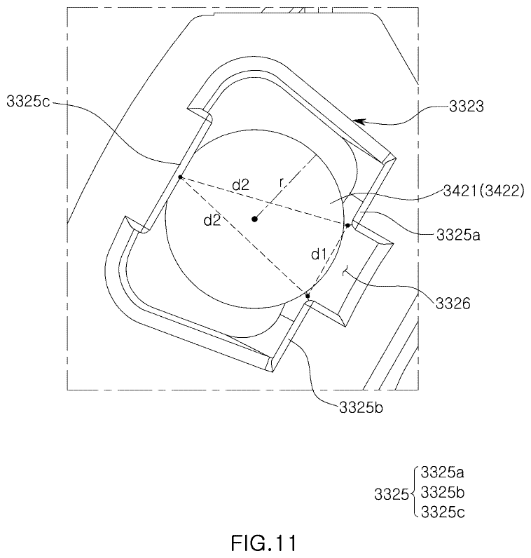

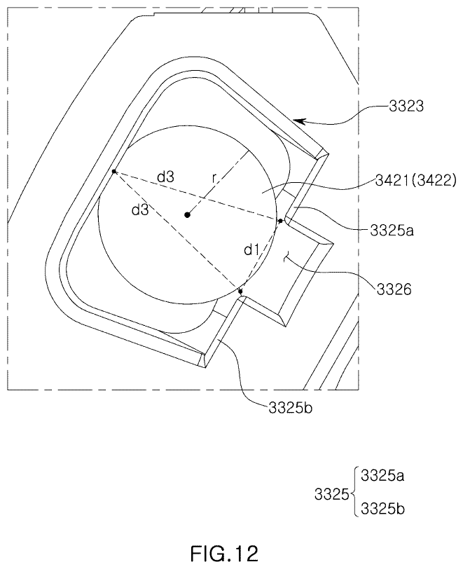

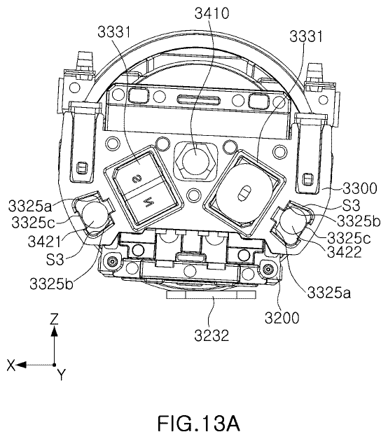

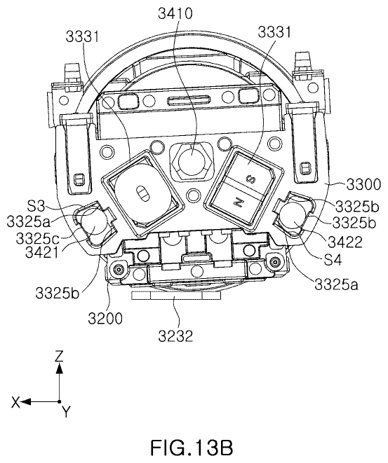

FIG. 10 is a bottom view of a rotation holder, in accordance with one or more embodiments. FIG. 11 is an enlarged view of a first guide groove provided in a rotation holder, in accordance with one or more embodiments. FIG. 12 is a diagram of a guide groove provided in another rotation holder, in accordance with one or more embodiments. FIGS. 13A and 13B are diagrams of a position of a guide ball when a rotation holder rotates, in accordance with one or more embodiments.

A bottom surface of the rotation holder 3300 may have a third accommodation groove 3321 that accommodates a portion of one rotation axis ball 3410, and two first guide grooves 3323 that respectively accommodate two guide balls 3421 and 3422. In an example embodiment, the first guide groove 3323 may be in the form of a straight line extending in an approximate direction of rotation of the rotation holder 3300, and the two guide balls 3421 and 3422 may move in a rolling motion in a direction of extension of the first guide groove 3323.

Referring to FIGS. 10 and 11, the first guide groove 3323 may include a plurality of partition walls 3325 protruding toward an internal space in which the guide balls 3421 and 3422 are accommodated. The plurality of partition walls 3325 may have an operation of limiting a range of movement of the guide balls 3421 and 3422 in the first guide groove 3323. In example embodiments, the plurality of partition walls 3325 may be separately installed in the first guide groove 3323 or may be a portion of the first guide groove 3323.

In an example, two or more partition walls 3325 may be provided. In an example embodiment, the first guide groove 3323 may include first to third partition walls 3325a, 3325b, and 3325c.

The first to third partition walls 3325a, 3325b, and 3325c may be provided on two side surfaces opposing each other, for example, two side surfaces extending in a direction, parallel to a direction of extension of the first guide groove 3323. In an example embodiment, the first partition wall 3325a and the second partition wall 3325b may be provided on one side surface (first side surface S1), among two side surfaces, parallel to the direction of extension of the first guide groove 3323, and the third partition wall 3325c may be provided on the other side surface (second side surface S2), among the two side surfaces. The first partition wall 3325a and the second partition wall 3325b may be disposed on one side surface of the first guide groove 3323 to be spaced apart from each other in the direction of extension of the first guide groove 3323. The third partition wall 3325c may be disposed on the other side surface of the first guide groove 3323 at a position opposing a separation space 3326 formed between the first partition wall 3325a and the second partition wall 3325b, spaced apart from each other.

According to an example, the two guide balls 3421 and 3422 may be positioned in a region of the first guide groove 3323, surrounded by the first to third partition walls 3325a, 3325b, and 3325c. In particular, even when positions of the guide balls 3421 and 3422 change as the rotation holder 3300 rotates, the centers of the two guide balls 3421 and 3422 may be positioned in a region surrounded by the first to third partition walls 3325a, 3325b, and 3325c. Accordingly, even when the guide balls 3421 and 3422 roll in a direction of rotation of the rotation holder 3300 in the first guide groove 3323 during rotation of the rotation holder 3300, the guide balls 3421 and 3422 may not be in contact with two side surfaces (third side surface S3 and fourth side surface S4), positioned in the direction of rotation of the rotation holder 3300. That is, the plurality of partition walls 3325 may have an operation of limiting a range of movement of the guide balls 3421 and 3422 such that the guide balls 3421 and 3422 are not in contact with the two side surfaces (third side surface and fourth side surface).

Referring to FIG. 11, a distance (d1) between a protruding portion (first point) of the first partition wall 3325a and a protruding portion (second point) of the second partition wall 3325b may be shorter, or less, than a radius (r) of the guide balls 3421 and 3422. In an example, a distance (d1) between a protruding portion (first point) of the first partition wall 3325a and a protruding portion (second point) of the second partition wall 3325b may be shorter, or less than a diameter of the guide balls 3421 and 3422. In an example, the protruding portion of the first partition wall 3325a and the protruding portion of the second partition wall 3325b may be portions that form contact points with the guide balls 3421 and 3422. Additionally, a distance (d2) between the respective protruding portions of the first partition wall 3325a and the second partition wall 3325b and a protruding portion (third point) of the third partition wall 3325c may also be shorter than, or less than, the diameter of the guide balls 3421 and 3422. In an example, the protruding portion (third point) of the third partition wall 3325c may be a portion that forms a contact point with the guide balls 3421 and 3422, and may be an approximately central portion of the protruding portion of the third partition wall 3325c.

Accordingly, the guide balls 3421 and 3422 may always remain in contact with at least one of the first to third partition walls 3325a, 3325b, and 3325c when they are accommodated in the first guide groove 3323. In an example, the guide balls 3421 and 3422 may form a contact with the third partition wall 3325c, may form a contact with the first partition wall 3325a and the second partition wall 3325b at the same time, or may form a contact with the first partition wall 3325a and the third partition wall 3325c (or the second partition wall 3325b and the third partition wall 3325c) at the same time.

In an example embodiment, when the rotation holder 3300 rotates about a second axis (Y-axis), the guide balls 3421 and 3422 may be in contact with the first partition wall 3325a and the third partition wall 3325c at the same time, or may be in contact with the second partition wall 3325b and the third partition wall 3325c at the same time.

Referring to FIG. 13A, when the rotation holder 3300 rotates counterclockwise (clockwise based on the drawings) about the second axis (Y-axis), the two guide balls 3421 and 3422 may move in a rolling motion when in contact with the second partition wall 3325b and the third partition wall 3325c. Specifically, when rotation begins, the guide balls 3421 and 3422 may be in contact with at least one of the first to third partition walls 3325a, 3325b, and 3325c. However, as the guide balls 3421 and 3422 move in a direction of rotation, the guide balls 3421 and 3422 may be in contact with the second partition wall 3325b and the third partition wall 3325c. A distance between a contact point between the guide balls 3421 and 3422 and the second partition wall 3325b and a contact point between the guide balls 3421 and 3422 and the third partition wall 3325c may be shorter than, or less than, the diameter of the guide balls 3421 and 3422. Accordingly, the guide balls 3421 and 3422 may remain in contact with the second partition wall 3325b and the third partition wall 3325c during rotation, thereby preventing the guide balls 3421 and 3422 from hitting a side surface positioned in a direction of rotation, for example, a third side surface, and sliding without further rolling.

Referring to FIG. 13B, when the rotation holder 3300 rotates clockwise (counterclockwise based on the drawings) about the second axis (Y-axis), the two guide balls 3421 and 3422 may move in a rolling motion when in contact with the first partition wall 3325a and the third partition wall 3325c. As described above, the guide balls 3421 and 3422 may remain in contact with the first and third partition walls 3325a and 3325c during rotation, thereby preventing the guide balls 3421 and 3422 from hitting a side surface positioned in a direction of rotation, for example, a fourth side surface, and sliding without further rolling.

In another example embodiment, the first guide groove 3323 may include two partition walls.

Referring to FIG. 12, the first guide groove 3323 may include a first partition wall 3325a and a second partition wall 3325b, and a third partition wall 3325c, (as illustrated in FIG. 11), may be omitted. In this example, the first partition wall 3325a and the second partition wall 3325b may be formed to further protrude toward an internal space of the first guide groove 3323, thereby limiting a range of movement of the guide balls 3421 and 3422. In an example, a distance (d3) between protruding portions of the first partition wall 3325a and the second partition wall 3325b and the other side surface (second side surface S2) of the first guide groove 3323, opposing thereto (specifically, a portion forming a contact point with the guide balls 3421 and 3422, a fourth point, may be an approximately central portion of the other side surface), may be shorter than, or less than, the diameter of the guide balls 3421 and 3422.

According to example embodiments, the two guide balls 3421 and 3422 may hit the plurality of partition walls 3325, provided at a position at which a small driving load occurs, instead of a side surface of the first guide groove 3323 positioned in a direction of rotation, and accordingly may roll when in contact with the plurality of partition walls 3325, thereby reducing driving power.

Since the first guide groove 3323 includes a plurality of partition walls 3325, the first guide groove 3323 and the second guide groove 1130 may have different cross-sections. In an example, the cross-sections of the first guide groove 3323 and the second guide groove 1130 may have different shapes in a first axis direction (X-axis direction).

The first guide groove 3323 may include a plurality of partition walls 3325, such that the cross-section of the first guide groove 3323 may have a width, narrower than a width of the cross-section of the second guide groove 1130. In an example embodiment, a portion of the guide balls 3421 and 3422, accommodated in the first guide groove 3323, may form a contact with a bottom surface of the first guide groove 3323 while forming a contact with at least one of the first to third partition walls 3325a, 3352b, and 3325c. That is, the guide balls 3421 and 3422 may be in contact with the first guide groove 3323 at at least two points. Conversely, the guide balls 3421 and 3422 may form a contact with a bottom surface of the second guide groove 1130, and may be in contact with the second guide groove 1130 at one point.

According to the above-described example embodiments, when the rotation holder 3300 rotates, an amount of movement of the two guide balls 3421 and 3422 in a rolling motion with respect to the rotation holder 3300 and an amount of movement of the two guide balls 3421 and 3422 in a rolling motion with respect to the housing 1100 may be different from each other. For example, an amount of movement of the guide balls 3421 and 3422 on the side of the rotation holder 3300 including the plurality of partition walls 3325 may be relatively limited. Accordingly, the two guide balls 3421 and 3422 may more stably support a movement of the rotation holder 3300.

The first guide groove 3323 and the second guide groove 1130 may include a reinforcement portion formed of a metal material. For example, the reinforcement portion may be formed integrally with the rotating holder 3300 and the housing 1100 formed of a plastic material using double injection.

A portion of the reinforcing portion may be exposed through the bottom surfaces of the first guide groove 3323 and the second guide groove 1130, and accordingly, the guide balls 3421 and 3422 accommodated therebetween may be in contact with the reinforcing portion. A metal material may have relatively high strength. Accordingly, even when the guide balls 3421 and 3242 roll while being in contact with the reinforcement portion, the guide balls 3421 and 3242 may be less likely to be deformed and damaged, thereby ensuring driving stability.

The third accommodation groove 3321, the fourth accommodation groove 1120, the first guide groove 3323, and the second guide groove 1130 may oppose each other in a second axis direction (Y-axis direction). In order to prevent the rotation axis ball 341 and the guide ball 3420 disposed therebetween from departing, the rotation holder 3300 may be supported by the housing 1100 in the second axis direction (Y-axis direction).

A second yoke 3334 may be disposed on a rear surface of the board 7000 on which the second driving coil 3332 is mounted. The second yoke 3334 may be disposed to oppose the second driving magnet 3331 with the second driving coil 3232 interposed therebetween.

The second yoke 3334 may have an operation of focusing a magnetic force of the second driving magnet 3331.

Additionally, the second yoke 3334 may form a magnetic attraction force with the second driving magnet 3331. A magnetic attraction force may be formed between the second yoke 3334 and the second driving magnet 3331 in opposing directions. Accordingly, the rotation holder 3300 may be supported by the housing 1100 to be in close contact with the housing 1100 in the second axis direction (Y-axis direction), with the second ball groups 3410 and 3420 interposed therebetween.

Additionally, a second position sensor 3333, which senses a position of the second driving magnet 3331, may be mounted on the board 7000. The second position sensor 3333 may be disposed on the inside or the outside of the second driving coil 3332, and one or more second position sensors 3333 may be provided.

The second position sensor 3333 may be a magnetic sensor, for example, a Hall sensor. The second position sensor 3333 may be disposed to oppose the second driving magnet 3331, and may sense a change in magnetic flux, thereby sensing an amount of movement of the second driving magnet 3331.

In an example embodiment, the second driving magnet 3331 may include a magnet that opposes the second driving coil 3332, and a magnet that opposes the second position sensor 3333. That is, one of the second driving magnets 3331 may be a driving magnet, and the other one may be a sensing magnet.

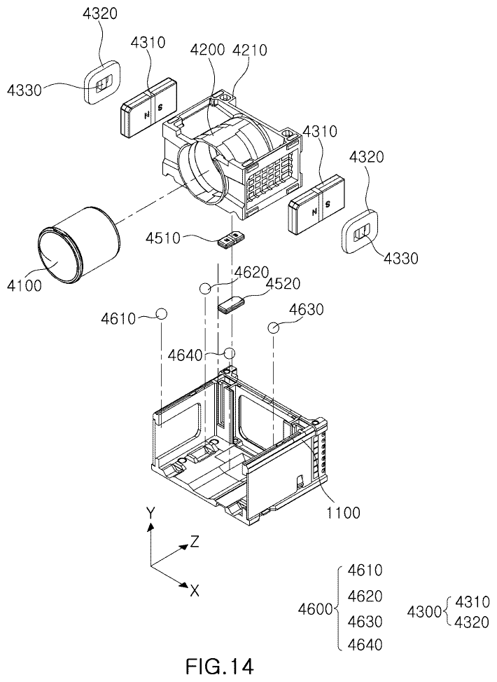

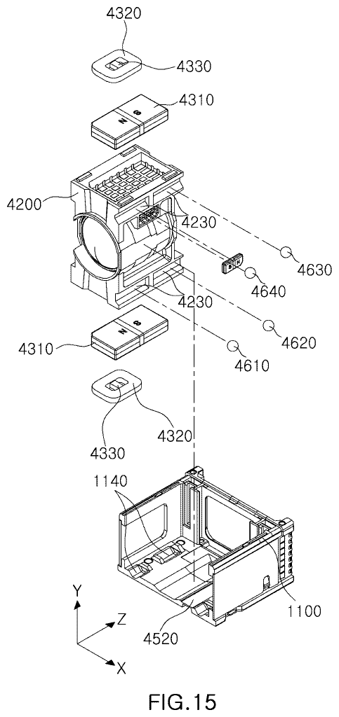

FIG. 14 is an exploded perspective view of a second lens module, in accordance with one or more embodiments. FIG. 15 is a bottom exploded perspective view of a second lens module, in accordance with one or more embodiments.

The second lens module 4000 may include an optical element. In an example embodiment, the second lens module 4000 may include at least one lens.

Referring to FIGS. 14 and 15, the second lens module 4000 may include a second lens barrel 4100 on which at least one lens is mounted, and a lens holder 4200 that accommodates the second lens barrel 4100. In an example, the second lens module 4000 may include one or more second lens barrels 4100 and/or lens holders 4200. One of the second lens barrel 4100 and the lens holder 4200 may be omitted.

The lens holder 4200 may move relative to the housing 1100 in an optical axis direction (Z-axis direction). The second lens barrel 4100 and at least one lens may move in the optical axis direction (Z-axis direction), together with the lens holder 4200.

A third ball group 4600, that guide a movement of the lens holder 4200 in the optical axis direction (Z-axis direction), may be disposed between the lens holder 4200 and the housing 1100. In a non-limited example, the third ball group 4600 may include at least three ball members. Referring to the attached drawings, the third ball group 4600 may include four ball members 4610, 4620, 4630, and 4640.

The second lens module 4000 may include a third driving unit 4300 that generates a driving force to move the lens holder 4200 in the optical axis direction (Z-axis direction).

The third driving unit 4300 may include a third driving magnet 4310 and a third driving coil 4320.

The third driving magnet 4310 may be disposed in the lens holder 4200. In an example embodiment, the third driving magnet 4310 may be disposed on a side surface of the lens holder 4200.

The third driving coil 4320 may be disposed in the housing 1100. Specifically, since the board 7000 on which the third driving coil 4320 is mounted may be coupled to the housing 1100, the third driving coil 4320 may be disposed in the housing 1100.

The third driving magnet 4310 and the third driving coil 4320 may oppose each other when disposed in the lens holder 4200 and the housing 1100, respectively.

The third driving magnet 4310 may be a moving member that is disposed in the rotation holder 4200, and the moving member may rotate together with the rotation holder 4200, and the third driving coil 4320 may be a fixed member that is fixedly disposed in the housing 1100. However, the one or more examples are not limited thereto, and positions thereof may be interchanged.

When power is applied to the third driving coil 4320, the lens holder 4200 may move in the optical axis direction (Z-axis direction) due to a driving force that is generated by an electromagnetic interaction between the third driving coil 4320 and the third driving magnet 4310.

The four ball members 4610, 4620, 4630, and 4640 may be disposed between the lens holder 4200 and the housing 1100. A first side and a second side of the lens holder 4200 may be respectively supported by two ball members, spaced apart from each other in the optical axis direction (Z-axis direction).

The lens holder 4200 and the housing 1100 may respectively have guide grooves 4230 and 1140 that accommodate a portion of the four ball members 4610, 4620, 4630, and 4640.

In an example embodiment, the lens holder 4200 may have four third guide grooves 4230 in which the four ball members 4610, 4620, 4630, and 4640 are respectively accommodated, and the housing 1100 may have four fourth guide grooves 1140.

The third guide groove 4230 and the fourth guide groove 1140 may extend in the optical axis direction (Z-axis direction) such that the four ball members 4610, 4620, 4630, and 4640 move in a rolling motion in the optical axis direction (Z-axis direction).

The four ball members 4610, 4620, 4630, and 4640 may be in contact with the third guide groove 4230 and the fourth guide groove 1140 at two points or one point. At least one of the four ball members 4610, 4620, 4630, and 4640 may be preferably supported at two points by at least one of the third guide groove 4230 and the fourth guide groove 1140.

A first side and a second side of the lens holder 4200 may include an extension portion 4210 that extends toward the image sensor 5000. In an example embodiment, the third guide groove 4230 may extend up to the extension portion 4210 to lengthen a stroke of the second lens module 4000.

The third guide groove 4230 and the fourth guide groove 1140 may oppose each other in a second axis direction (Y-axis direction). In order to prevent the four ball members 4610, 4620, 4630, and 4640 disposed between the third guide groove 4230 and the fourth guide groove 1140 from departing, the lens holder 4200 may be supported by the housing 1100 in the second axis direction (Y-axis direction).

The lens holder 4200 may be supported by the housing 1100 by a magnetic force generated between a pair of magnetic bodies 4510 and 4520.

The pair of magnetic bodies 4510 and 4520 may include a third magnetic body 4510 disposed in the lens holder 4510, and a fourth magnetic body 4520 disposed in the housing 1100. The third magnetic body 4510 and the fourth magnetic body 4520 may be disposed to oppose each other in the second axis direction (Y-axis direction).

In an example embodiment, the third magnetic body 4510 may be a pulling magnet, and the fourth magnetic body 4520 may be a pulling yoke. A magnetic attraction force may be formed between the third magnetic body 4510 and the fourth magnetic body 4520 in opposing directions. Accordingly, the lens holder 4200 may be supported by the housing 1100 to be in close contact with the housing 1100 in the second axis direction (Y-axis direction), with the four ball members 4610, 4620, 4630, and 4640 interposed therebetween.

In order to stably support the lens holder 4200, the third magnetic body 4510 may be disposed to be positioned in a support region formed by the four ball members 4610, 4620, 4630, and 4640.

In an example embodiment, the support region may have a rectangular shape using the four ball members 4610, 4620, 4630, and 4640 as vertices, and the third magnetic body 4510 may be disposed in the rectangular support region. Accordingly, a point of application of a magnetic force, formed between the third magnetic body 4510 and the fourth magnetic body 4520, may be positioned in the support region, and the lens holder 4200 may be stably supported by the housing 1100.

A third yoke 4340 may be disposed on a rear surface of the board 7000 on which the third driving coil 4320 is mounted. The third yoke 4340 may be disposed to oppose the third driving magnet 4310 with the third driving coil 4320 interposed therebetween.

The third yoke 4340 may have a function of focusing a magnetic force of the third driving magnet 4310.

Additionally, a third position sensor 4330, that senses a position of the third driving magnet 4310, may be mounted on the board 7000. The third position sensor 4330 may be disposed on the inside or the outside of the third driving coil 4320, and one or more third position sensors 4330 may be provided.

The third position sensor 4330 may be a magnetic sensor, for example, a Hall sensor, as an example. The third position sensor 4330 may be disposed to oppose the third driving magnet 4310, and may sense a change in magnetic flux, thereby sensing an amount of movement of third driving magnet 4310.

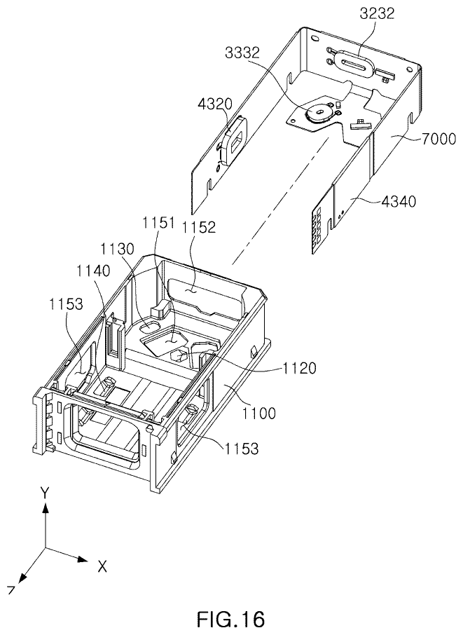

FIG. 16 is a diagram of a board separated from a, in accordance with one or more embodiments.

As illustrated in FIG. 16, the board 7000 may be coupled to the housing 1100. The board 7000 may be coupled to side surfaces of the housing 1100 other than one side surface of the housing 1100 on which the image sensor 5000 is disposed, and a portion of a bottom surface of the housing 1100.

The first to third driving coils 3232, 3332, and 4320 and the first to third position sensors 3233, 3333, and 4330, included in the above-described first to third driving units 3230, 3330, and 4300, may be mounted on one surface of the board 7000. Additionally, the first to third yokes 3234, 3334, and 4340 may be disposed on a rear surface of the board 7000.

A portion of the housing 1100 to which the board 7000 is coupled may have through-holes 1151, 1152, and 1153, and accordingly the first to third coils 3232, 3332, and 4320 disposed on the board 7000 may be exposed to an internal space of the housing 1100, and may directly oppose the first to third magnets 3231, 3331, and 4310 disposed in the reflection module 3000 and the second lens module 4000, respectively.

In an example embodiment, the first to third coils 3232, 3332, and 4320 may be mounted on one board 7000. In this example, the first to third coils 3232, 3332, and 4320 may be disposed on different surfaces of the housing 1100, such that at least a portion of the board 7000 may be bent. However, in another example embodiment, the first to third driving coils 3232, 3332, and 4320 may be mounted on different boards and coupled to the housing 1100.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a housing;
a rotation holder, supported by the housing, and configured to rotate together with a reflective member; and
a first plurality of ball members disposed between the housing and the rotation holder,
wherein the housing and the rotation holder respectively have guide grooves that accommodate a first set of ball members of the first plurality of ball members, and
a first set of guide grooves, among the guide grooves, comprise a plurality of partition walls that protrude toward an internal space of the guide grooves in which the first set of ball members of the first plurality of ball members are accommodated, and are disposed to be spaced apart from each other in a direction of extension of the guide groove.

2. The camera module of claim 1, wherein the guide grooves comprise:
a first guide groove provided on the rotation holder, the first guide groove extending approximately in a direction of rotation of the rotation holder; and
a second guide groove provided on the housing to correspond to the first guide groove,
wherein the first guide groove comprises the plurality of partition walls.

3. The camera module of claim 2, wherein:
the plurality of partition walls comprise a first partition wall and a second partition wall disposed to be spaced apart from each other in a direction of extension of the first guide groove, and
a first distance between a first point of the first partition wall in contact with a ball member accommodated in the first guide groove and a second point of the second partition wall in contact with the ball member accommodated in the first guide groove is less than a diameter of the ball member accommodated in the first guide groove.

4. The camera module of claim 3, wherein the plurality of partition walls further comprise a third partition wall disposed to oppose a separation space formed between the first partition wall and the second partition wall.

5. The camera module of claim 4, wherein a second distance between the first point of the first partition wall and the second point of the second partition wall in contact with the ball member accommodated in the first guide groove and a third point of the third partition wall in contact with the ball member accommodated in the first guide groove is less than the diameter of the ball member accommodated in the first guide groove.

6. The camera module of claim 5, wherein the third point is disposed at approximately a central portion of the third partition wall.

7. The camera module of claim 3, wherein a third distance between the first point of the first partition wall and the second point of the second partition wall in contact with the ball member accommodated in the first guide groove and a fourth point of one side surface of the first guide groove, opposing the first partition wall and the second partition wall, in contact with the ball member accommodated in the first guide groove is less than the diameter of the ball member accommodated in the first guide groove.

8. The camera module of claim 1, wherein the first plurality of ball members comprise:
a rotation axis ball that forms a rotation axis of the rotation holder; and
a plurality of guide balls that are disposed spaced apart from the rotation axis ball and are accommodated in the guide groove.

9. The camera module of claim 1, further comprising:
a reflective holder supported by the rotation holder, and configured to rotate together with the reflective member; and
a second plurality of ball members disposed between the rotation holder and the reflective holder,
wherein the rotation holder and the reflective holder are each configured to rotate about axes, perpendicular to each other.

10. The camera module of claim 2, wherein:
the first set of ball members of the first plurality of ball members are disposed between the first guide groove and the second guide groove, and
a number of contact points between the first set of ball members of the first plurality of ball members and the first guide groove is greater than a number of contact points between the first set of ball members of the first plurality of ball members and the second guide groove.

11. A camera module, comprising:
a rotation holder accommodated in a housing and configured to rotate about a first axis;
a plurality of ball members disposed between the housing and the rotation holder; and
a first guide groove that accommodates a first set of ball members, among the plurality of ball members, and extending approximately in a direction of rotation of the rotation holder,
wherein the first guide groove has a first side surface and a second side surface opposing each other and extending in a direction of rotation of the rotation holder, and a third side surface and a fourth side surface positioned on the direction of rotation of the rotation holder and connecting the first side surface and the second side surface to each other, and
the first set of ball members are accommodated in the first guide groove, and are in contact with at least one side surface, among the first side surface and the second side surface, and are disposed apart from the third side surface and the fourth side surface during the rotation of the rotation holder.

12. The camera module of claim 11, wherein:
at least one of the first side surface and the second side surface comprises a partition wall that protrudes toward an internal space of the first guide groove, and
the first set of ball members are in contact with the partition wall.

13. The camera module of claim 12, wherein one of the first side surface and the second side surface comprises a first partition wall and a second partition wall disposed to be spaced apart from each other in a direction of extension of the first guide groove.

14. The camera module of claim 13, wherein the one of the first side surface and the second side surface further comprises a third partition wall disposed to oppose a separation space formed between the first partition wall and the second partition wall.

15. The camera module of claim 14, wherein a distance between a first point of the first partition wall in contact with the first set of ball members and a second point of the second partition wall in contact with the first set of ball members, and a distance between the first point of the first partition wall and the second point of the second partition wall and a third point of the third partition wall in contact with the first set of ball members are respectively less than a diameter of the first set of ball members.

16. The camera module of claim 13, wherein:
a distance between a first point of the first partition, in contact with the first set of ball members, and a second point of the second partition, in contact with the first set of ball members, and a distance between the first point of the first partition and the second point of the second partition and a fourth point of one side surface of the first guide groove opposing the first partition wall and the second partition wall, in contact with the first set of ball members, is respectively less than a diameter of the first set of ball members.

17. The camera module of claim 11, wherein:
the housing has a second guide groove that opposes the first guide groove, and accommodates a second set of ball members of the plurality of ball members accommodated in the first guide groove, and
the second guide groove has a cross-sectional shape in at least one direction, different from a cross-sectional shape of the first guide groove.

18. The camera module of claim 17, wherein a number of contact points between the first set of ball members and the first guide groove is greater than a number of contact points between the first set of ball members and the second guide groove.
